(19) United States
(12) Patent Application Publication
(10) Pub. No.: US 2008/0066466 A1
(43) Pub. Date: Mar. 20, 2008

(54) DEVICE FOR ACCELERATING A TURBOCHARGER UNIT AT LOW SPEEDS OF A RECIPROCATING ENGINE, AND A RECIPROCATING ENGINE INCLUDING SUCH A DEVICE

(76) Inventor: Jean Frederic Melchior, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/859,185

(22) Filed: Sep. 21, 2007

Related U.S. Application Data
(63) Continuation of application No. PCT/FR2006/000600, filed on Mar. 17, 2006.

(30) Foreign Application Priority Data
Mar. 22, 2005 (FR) 0502838

(51) Int. Cl. F02B 37/12; F02D 23/00; F02B 37/16

(52) U.S. Cl. 60/600; 60/604; 60/605.1; 60/605.2; 60/612

(57) ABSTRACT

The invention relates to a device for accelerating a turbocharger unit at low speeds of a reciprocating engine (1) operating with a four-stroke cycle and including at least one cylinder (1a) provided with at least one admission valve (2) connected to an admission manifold (3) and at least one exhaust valve (4) connected to an exhaust manifold (5), said turbocharger unit comprising at least one turbocharger (10) comprising an air compressor (11) feeding the admission manifold (3) and a radial-flow turbine (12) fed by the exhaust manifold (5) and driving the compressor (11). The device includes an aerodynamic ejector (20) taking a driving flow from the exhaust gas of the engine (1) and a driven flow delivered by the compressor (11) and forming a mixed flow that feeds the turbine (12) of the turbocharger unit (10).

### CROSS REFERENCE TO RELATED APPLICATIONS

This application is a Continuation Application of International Application No. PCT/FR2006/000600, filed Mar. 17, 2006, which claims priority from French patent Application No. 0502838, filed Mar. 22, 2005.

### FIELD AND BACKGROUND OF THE INVENTION

The present invention relates to a device for accelerating a turbocharger unit at low speeds of a reciprocating engine operating with a four-stroke cycle, and to a reciprocating engine fitted with such a device for accelerating the turbocharger unit.

The invention also relates to methods of accelerating a turbocharger unit at low speeds of a reciprocating engine operating with a four-stroke cycle.

Turbocharged four-stroke diesel engines, e.g. such as those described in French patent applications Nos. 03/03728 and 05/01156 in the name of the Applicant, are characterized by a high-pressure turbocharger unit adapted for a speed of rotation that is slower than their minimum utilization speed in order to recycle an exhaust gas flow under all operating conditions of the engine. The adaptation speed of a turbocharger unit is the speed of rotation of the engine at which the gas pressure upstream from the turbine of the turbocharger unit matches the air pressure downstream from the compressor of said turbocharger unit.

Presently-known turbocharger units are poorly adapted to motor vehicle engines of small cylinder capacity (displacement), e.g. of the order of 1500 cubic centimeters (cm³). Miniaturization of turbocharger units encounters limits for rotor diameters close to 30 millimeters (mm). At such a size, it is not possible to envisage any kind of variable geometry without severely compromising isentropic efficiency in compression and in expansion.

Overdimensioning high-pressure turbocharger units is particularly penalizing for engines that have a particle filter, particularly when the filter is disposed upstream from the turbine of said turbocharger unit. Under such circumstances, the high-pressure turbine does not benefit from pressure waves in order to accelerate from the idling speed of the engine. Furthermore, no gas flow can be recycled to the engine admission at very low speeds for the purpose of limiting nitrogen oxide (NOx) emissions and maintaining the temperature of the particle filter catalyst.

In order to improve acceleration of the turbocharger unit at low engine speeds, car manufacturers have underdimensioned the turbine of the turbocharger unit and have associated the turbine with a discharge valve or an inlet of variable section. However, the extent to which the turbine can be underdimensioned is limited by the maximum power of the engine.

The manufacturers of turbocharger units have also proposed driving the turbocharger electrically or hydraulically when the engine is operating at low speeds. However that solution is expensive and is not sufficiently powerful for high supercharge ratios.

The method described in French patent application No. 03/03728, also in the name of the Applicant, enables that problem to be solved for engines having a cylinder capacity greater than 1900 cm³.

### SUMMARY OF THE INVENTION

An object of the present invention is to solve this problem by proposing a device that is capable of generating a recycled exhaust gas flow at speeds slower than the adaptation speed and of accelerating the high-pressure turbocharger unit without causing the compressor of the unit to pump at said speed.

The invention thus provides a device for accelerating a turbocharger unit at low speeds of a reciprocating engine operating with a four-stroke cycle and including at least one cylinder provided with at least one admission valve connected to an admission manifold and at least one exhaust valve connected to an exhaust manifold, said turbocharger unit comprising at least one turbocharger comprising an air compressor feeding the admission manifold and a radial-flow turbine fed by the exhaust manifold and driving the compressor, the device being characterized in that it includes an aerodynamic ejector taking a driving flow from the exhaust gas of the engine and a driven flow delivered by the compressor and forming a mixed flow that feeds the turbine of the turbocharger unit.

According to other characteristics of the invention:
the ejector includes a mixer that is formed by the feed volute of the turbine being extended upstream, relative to the flow direction of the mixed flow, by a substantially rectilinear portion of length that is sufficient to ensure uniform mixing between the driving flow and the driven flow;
the substantially rectilinear portion of the mixer is extended upstream by a substantially conical portion on the same axis and having an angle at the apex lying, for example, in the range 20° to 40°, and in communication with the exhaust manifold;
the ejector includes a cylindrical tube having an outside wall that is provided at one of its ends with a conical portion for co-operating with the conical portion of the mixer, said tube being movable along the axis of said mixer so that the two conical portions form an annular converging nozzle of variable section for accelerating the driving flow;
the cylindrical tube is mounted to slide in leaktight manner in a guide provided in the wall of the exhaust manifold and communicates with the outlet from the compressor via a check valve that prevents exhaust gas flowing from the exhaust manifold towards the compressor;
the section of the nozzle varies between the inlet section of the volute of the turbine and one-third of said inlet section;
the cylindrical tube is secured at its end opposite from its end provided with the conical portion, to a control piston mounted to slide in a cylinder that defines on one side of the piston a first chamber that is subjected to the pressure of the air delivered by the compressor, and on the other side of the control piston, a second chamber containing a spring acting on the piston, said pressure of the air delivered by the compressor tending to open the nozzle of the ejector, and the force of the spring tending to close the nozzle;
the second chamber communicates with a vacuum pump in order to modify or neutralize the force of the spring; and
the turbocharger unit includes a second turbocharger comprising a turbine in permanent communication with the exhaust manifold and a compressor in permanent communication with the admission manifold, and the compressor communicates with the admission manifold via a check valve.

The invention also provides a reciprocating engine operating with a four-stroke cycle and including a turbocharger unit, the engine being characterized in that it includes a device as mentioned above for accelerating the turbocharger unit at low engine speed.

The invention also provides a method of accelerating a turbocharger unit at low speeds of a reciprocating engine operating with a four-stroke cycle and including a device as mentioned above for accelerating said turbocharger unit, the method being characterized in that it consists in closing the nozzle of the aerodynamic ejector.

The invention also provides a method of accelerating a turbocharger unit at low speeds of a reciprocating engine operating with a four-stroke cycle and including a device as mentioned above for accelerating the turbocharger unit, together with a duct for recycling exhaust gas, the method being characterized in that it consists in obstructing said recycling duct, the section of the nozzle of the ejector being constant.

The invention also provides a method of accelerating a turbocharger unit at low speeds of a reciprocating engine, said unit including two turbochargers, the method being characterized in that it consists:
between idling speed and a speed N1 where the admission pressure P2 reaches the value desired as a function of the burnt fuel flow rate, in maintaining the discharge valve, the check valve, and the nozzle closed so that the engine is fed with air solely by the compressor of the turbocharger driven by the turbine of said turbocharger that receives all of the exhaust gas from the engine; and
between said speed N1 and a speed Nt at which the exhaust delivered by the compressor of the turbocharger reaches the admission exhaust P2, in maintaining said admission pressure P2 at its setpoint value by progressively opening the nozzle, the discharge valve and the check valve remaining closed so that the engine is fed with air solely by the compressor of the turbocharger driven by the turbine that receives only a fraction of the exhaust gas from the engine, with the remainder feeding the turbine via the aerodynamic ejector, thereby driving the compressor that delivers solely into the turbine via said aerodynamic ejector.

### BRIEF DESCRIPTION OF THE DRAWINGS

Other characteristics and advantages of the invention appear from the following description made with reference to the accompanying drawings, in which:

FIG. 1 is a diagram of a cylinder of a reciprocating engine fitted with a device for accelerating a turbocharger unit having one turbocharger;

FIG. 2 is a diagram of a variant of a cylinder of a reciprocating engine fitted with a device for accelerating a turbocharger unit having one turbocharger;

FIG. 3 is a diagram of a cylinder of a reciprocating engine fitted with a prior art turbocharger unit having two turbochargers; and

FIG. 4 is a diagram of a cylinder of a reciprocating engine fitted with a turbocharger unit having two turbochargers and including a device for accelerating a turbocharger unit having two turbochargers.

### MORE DETAILED DESCRIPTION

The figures are diagrams showing an engine 1 including at least one cylinder 1a fitted with at least one admission valve 2 connected to an admission manifold 3, and with at least one exhaust valve 4 connected to an exhaust manifold 5. The engine 1 operates with a four-stroke cycle, preferably without the valves 2 and 4 overlapping, so as to prevent any direct communication between the admission manifold 3 and the exhaust manifold 5.

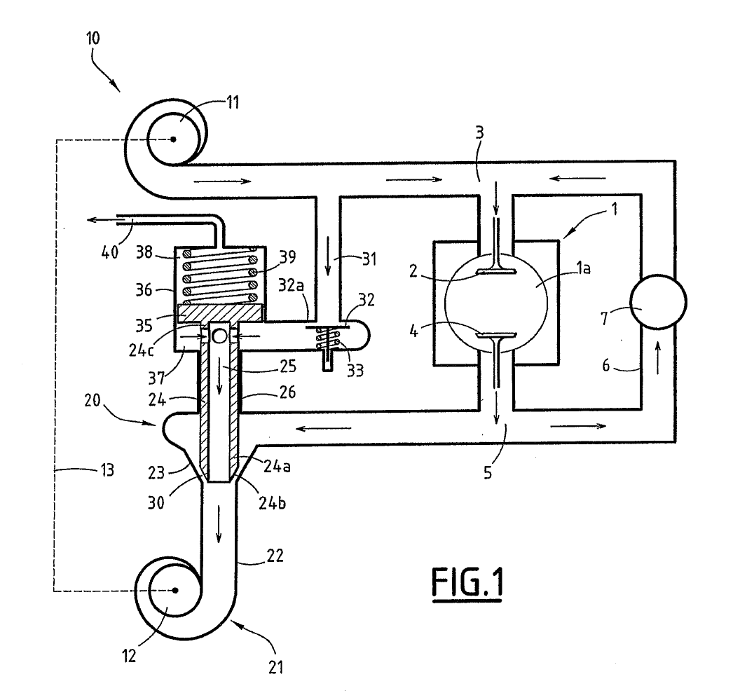

In FIG. 1, the engine 1 is supercharged by a turbocharger unit comprising a turbocharger given overall reference 10 and comprising an air compressor 11 feeding the admission manifold 3, and a radial-flow turbine 12 fed by the exhaust manifold 5 and driving the compressor 11 via mechanical means represented in the figure by dashed line 13. The engine 1 is also fitted with an exhaust gas recirculation (EGR) duct 16 fitted with an adjustment valve 7, commonly referred to as an EGR valve.

The engine 1 is fitted with a device for accelerating the turbocharger unit at low engine speeds, which device comprises an aerodynamic ejector given overall reference 20.

In general manner and as described below, the aerodynamic ejector 20 takes a driving flow from the exhaust gas of the engine 1 and a driving flow from the air delivered by the compressor 11, and forms a mixed flow that feeds the turbine 12 of the turbocharger 10.

The aerodynamic ejector 20 comprises a mixer 21 that is formed, in the embodiment shown in FIG. 1, by the feed volute of the turbine 12. The mixer 21 is extended upstream relative to the flow direction of the mixed flow by a substantially rectilinear portion 22 of length that is sufficient to ensure uniform mixing between the driving flow and the driven flow of the aerodynamic ejector 20. This substantially rectilinear portion 22 is extended by a substantially conical portion 23 on the same axis and presenting an angle at the apex that lies, for example, in the range 20° to 40°. The portion 23 communicates with the exhaust manifold 5.

In the embodiment shown in FIG. 1, the ejector 20 also includes a cylindrical tube 24 that forms an internal duct 25 and that has its outside wall provided at one of its ends 24a with a conical portion 24b for co-operating with the conical portion 23 of the mixer 20.

The cylindrical tube 24 is mounted to slide in leaktight manner in a guide 26 that presents an inside section of shape complementary to the shape of the outside wall of the cylindrical tube 24. The cylindrical tube 24 is movable along the axis of the mixer 21 so that the conical portions, respectively 23 and 24b, co-operate to form an annular converging nozzle 30 of variable section for accelerating the driving flow.

The cylindrical tube 24 communicates with the outlet from the compressor 11 by means of a bypass duct 31 via a check valve 32 that prevents exhaust gas from flowing from the exhaust manifold 5 towards the compressor 11. For this purpose, the check valve 32 is associated with a spring 33 whose return force tends to press the member of the valve 32 against its seat 32a so as to close the bypass duct 31.

The cylindrical tube 24 includes, at its end 24c opposite from its end provided with the conical portion 24b, a control piston 35 that is slidably mounted in a cylinder 36 that defines on one side of the piston 35 a first chamber 37 that is subjected to the pressure of the air delivered by the compressor 11 via the bypass duct 31, and on the other side of the control piston 35, a second chamber 38 containing a spring 39 that acts on the piston 35. The pressure of the air delivered by the compressor 11 and passing via the bypass duct 31 tends to open the nozzle 30 by moving the cylindrical tube 24 by means of the piston 35, while the force exerted by the spring 39 on the piston 35 tends to close the nozzle 30.

In the embodiment shown in FIG. 1, the second chamber 38 communicates via a pipe 40 with a vacuum pump (not shown) that makes it possible, under certain circumstances, to modify or to neutralize the force of the spring 39. The section of the nozzle 30 preferably varies between the inlet section of the volute of the turbine 12 and one-third of said inlet section.

A four-stroke engine without valve overlap generates an exhaust gas flow rate that is proportional to the speed of the engine and to the density of the gas in the admission manifold 3. The pressure of the gas delivered by the engine 1 at a given speed thus depends only on the section of the exhaust orifice, specifically the inlet of the turbine 12.

To accelerate the compressor 11, the turbine 12 must receive a flow rate of gas presenting total pressure and/or total temperature greater than that of the flow rate of air delivered by the compressor 11. The flow rate of air delivered by the compressor 11, equal to the flow rate passing through the turbine 12, must also be greater than the pumping flow rate, i.e. the rate where operation is unstable. At idling speeds, the flow rate sucked in by the engine 1 is below this minimum flow rate and the pressure at which exhaust gas is delivered is negligible, given the overdimensioning of the turbine 12.

In the device of the invention, as shown in FIG. 1, the compressor 11 delivers in parallel into the admission circuit of the engine 1 and into the bypass duct 31 that feeds the turbine 12 directly. The turbine 12 is thus fed simultaneously by air coming from the bypass duct 31 and by the exhaust gas delivered by the engine 1.

In the device of the invention, the engine 1 is used as a compressed gas generator that drives a portion of the air flow delivered by the compressor 11 into the feed volute of the turbine 12 by means of the aerodynamic ejector 20. The hot gas accelerated by the nozzle 30 of the aerodynamic ejector communicates its momentum to the air delivered by the bypass duct 31 by means of the ejector 20 whose mixer 21 feeds the volute of the turbine 12. The section of the nozzle 30 of the ejector 20 is adjustable, thus making it possible to control the ratio between the flow rate of driving gas and the flow rate of the driven air. In operation, the section of the nozzle 30 can be set between a minimum value that enables the turbocharger unit to be accelerated and that enables recycled exhaust gas to be delivered at the desired rate while idling, and the normal section for feeding the turbine 12 of the turbocharger unit.

For operation at idling speed, the nozzle 30 is set to its minimum section. The adjustment valve 7 is open and sets the flow rates of recycled hot gas so as to ensure that the quantity of air in the cylinder 1a is just sufficient for burning the fuel at its flow rate for maintaining idling, and that the admission temperature is as high as possible in order to limit noise and incomplete combustion. Richness is preferably determined by the computer controlling the engine 1. Under such conditions, the admission pressure in the admission manifold 3 is close to atmospheric pressure, and the exhaust pressure in the exhaust manifold 5 is slightly greater than atmospheric pressure.

In order to increase the pressure of the air delivered by the turbocharger unit without changing the idling speed of the engine 1, it suffices to close the adjustment valve 7 without modifying the section of the nozzle 30. The pressure in the exhaust manifold 5 increases, as does the speed of the jet emitted by the nozzle 30, which entrains a flow of air through the bypass duct 31, and transfers its momentum thereto in the mixer 21. Since the total pressure upstream from the turbine 12 is greater than the pressure delivered by the compressor 11, the compressor accelerates up to a maximum speed when the adjustment valve 7 is closed. The engine 1 is thus supercharged at its idling speed, and is capable of delivering torque for accelerating the vehicle.

When the engine 1 accelerates in order to reach the adaptation speed, the nozzle 30 of the ejector 20 needs to be opened progressively to its normal section for feeding the turbine 12 so as to limit gas pressure in the exhaust manifold 5. The percentage of air entrained towards the turbine 12 then decreases down to zero, and the check valve 32 closes to prevent hot gas flowing back towards the outlet from the compressor 11. This operation is governed by the spring 39 bearing against one face of the piston 35 whose other face is subjected to the pressure delivered by the compressor 11. The stiffness and the setting of the spring 39 determine the air pressure levels that are accessible with this mode of regulation. This mode of regulation can be modified or eliminated by putting the chamber 38 that includes the spring 39 into communication with a vacuum pump via an electrically controlled three-port valve (not shown). The progressive opening of the nozzle 30 of the ejector 20 may be accompanied by partial opening of the adjustment valve 7 so as to maintain the recycled gas concentration at desired value. Between idling and a speed that is equal to twice the adaptation speed, the device of the invention enables a high concentration of recycled gas to be maintained and/or enables high torque to be delivered.

Preferably, the adjustment valve 7 controls the concentration of recycled gas, and the nozzle 30 of the ejector 20 actuated by the piston 35 controls the richness of combustion in the engine. An advantage of the device of the invention is that it controls admission temperature, thus making it possible to make use of low compression ratios in cold weather.

Another advantage of the device of the invention is the engine braking that is obtained by simultaneously closing both the adjustment valve 7 and the nozzle 30 of the aerodynamic ejector 20.

Each time the driver raises the foot on the accelerator pedal, the nozzle 30 can close and the adjustment valve 7 can open to feed the engine with hot gas so as to avoid cooling the devices for post-treatment of the exhaust gas.

If the driver desires to slow down the vehicle by actuating the brake pedal, it can act on a priority basis to close the adjustment valve 7 so as to increase the exhaust back pressure and create engine braking. The kinetic energy of the vehicle is then used to drive the turbocharger unit 10, thus enabling it to respond immediately when braking comes to an end.

The invention makes available numerous strategies for controlling the operation of the engine, and that are familiar to the person skilled in the art.

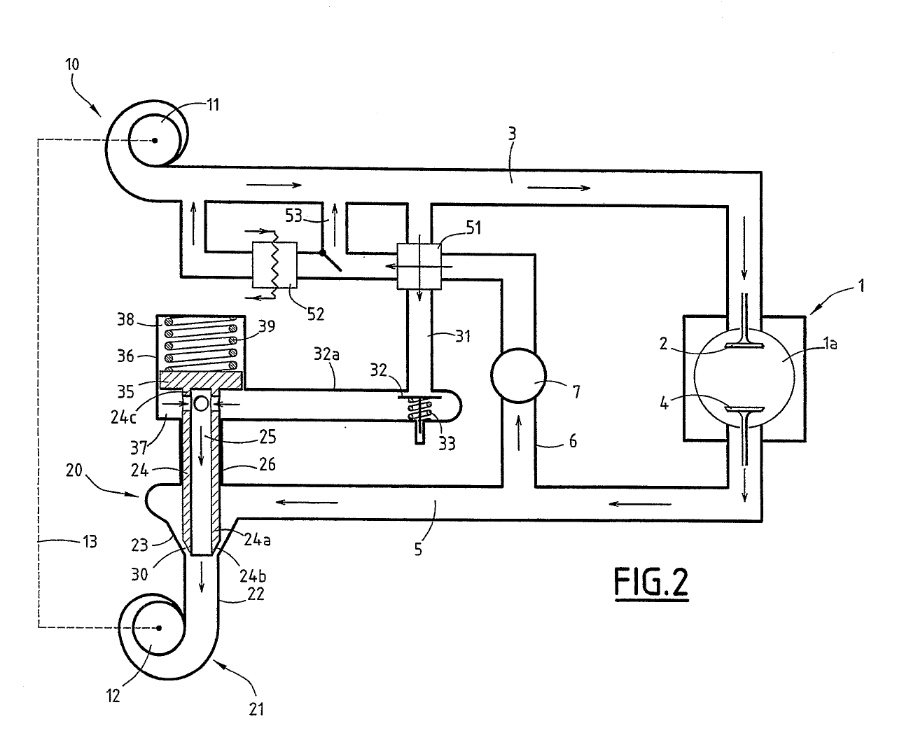

When the engine 1 is fitted with an EGR duct 6, as shown in FIG. 2, the efficiency of the device of the invention can be improved by heating the air that feeds the ejector 20 via the duct 31.

A solution shown in FIG. 2 consists in placing an air and exhaust gas heat exchanger 51 at an intersection between the duct 31 and the duct 6. Generally, the duct 6 includes a gas/water cooler 52 and a bypass duct 53 for bypassing the cooler. The heat exchanger 51 is then placed upstream from the cooler 52 and from the bypass duct 53.

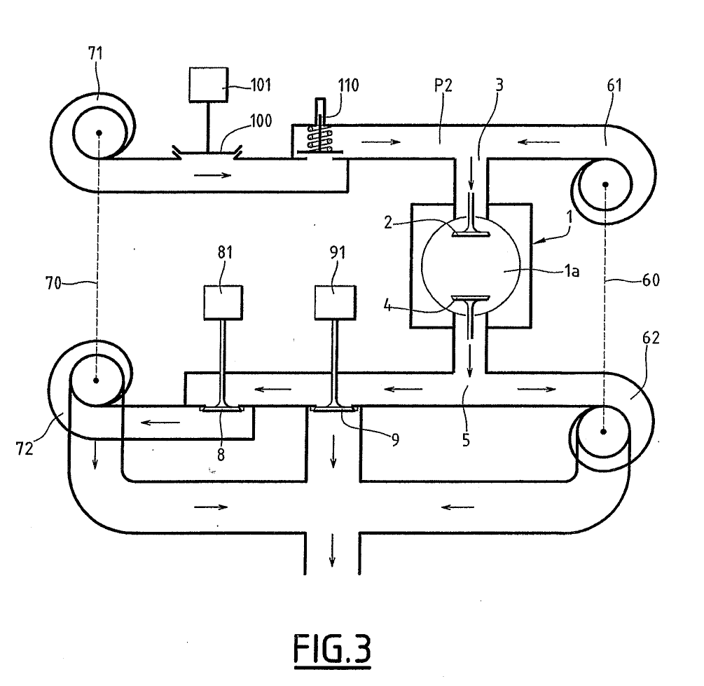

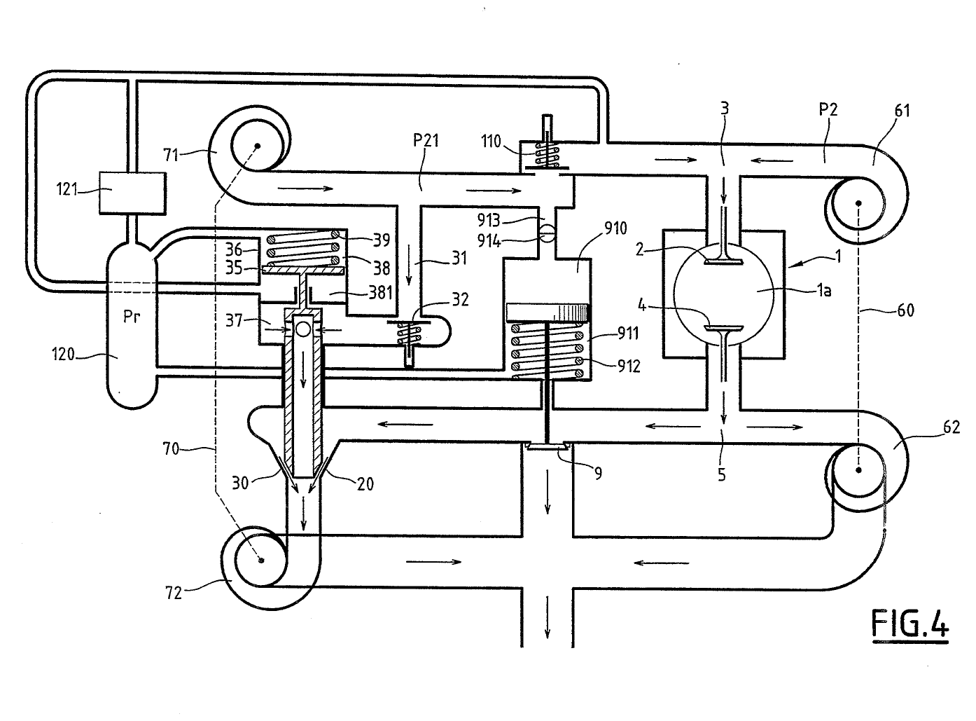

With reference now to FIGS. 3 and 4, there follows a description of another application of the device for accelerating a turbocharger unit.

In addition to accelerating the compressor at low engine speeds, the acceleration device of the invention is particularly advantageous in a sequential turbocharger unit comprising two turbines and two compressors that are connected in parallel for expanding the exhaust gas and compressing the air admitted to the engine.

In such a configuration, the first turbocharger that comprises a turbine and a compressor operates on its own between idling and an intermediate speed known as the transition speed Nt, above which the second turbocharger that likewise comprises a turbine and a compressor, co-operates with the first turbocharger in order to feed air to the engine. Putting the second turbocharger into action raises problems similar to acceleration at low speed, and this occurs on each occasion speed increases, while similar problems are raised when stopping the second turbocharger, as occurs on each occasion speed decreases. The frequency of these transitions can be high during urban or sporty driving, and can make it difficult to control the valves for regulating the gas flows.

In FIGS. 3 and 4, members that are common to the embodiment described above are designated by the same references.

FIG. 3 shows an engine of known type that includes an admission duct 3 and an exhaust duct 5, and that is supercharged by a turbocharger unit comprising two turbochargers referenced respectively 60 and 70, each comprising a respective compressor 61 or 71 and a respective turbine 62 or 72.

The compressor 61 sucks in air from the atmosphere and delivers it continuously to the admission manifold 3, and the turbine 62 is in continuous communication with the exhaust manifold 5 that feeds it with hot gas that it exhausts to the atmosphere. The compressor 71 sucks in air from the atmosphere for delivery into the admission manifold 3 via a check valve 110. The turbine 72 communicates with the exhaust manifold 5 via a feed valve 8 controlled by an actuator 81.

The exhaust manifold 5 is provided with a discharge valve 9 for discharging to the atmosphere and controlled by an actuator 91, and the admission manifold 3 is provided with a discharge valve 100 for discharging to the atmosphere, situated upstream from the valve 110, and controlled by an actuator 101.

Between idling speed and a speed N1, the valves 8, 9, 10, and 11 are closed and all of the exhaust flow is fed to the turbine 62, which accelerates the compressor 61 up to the desired admission pressure P2.

Between the speed N1 and a higher transition speed Nt, the air flow rate increases at constant pressure P2 by progressively opening the discharge valve 9. The speed Nt must be fast enough to enable the engine 1 to act after the transition to suck in air at a flow rate greater than the sum of the pumping flow rate of the two compressors 61 and 71 together. If the two compressors 61 and 71 are identical and the turbocharger 60 is adapted to the vicinity of the pumping line, then the speed Nt is greater than 2 N1.

Starting from the speed Nt, the valve 8 opens to feed the turbine 72, while the discharge valve 9 closes to maintain the pressure P2. The compressor 71 accelerates quickly delivering through the discharge valve 10 that is regulated to avoid pumping.

When the pressure of the compressor 71 reaches the pressure P2, the valve 11 opens, the discharge valve 10 closes, and the two compressors 61 and 71 share the delivery of air to the engine 1 pro rata the sections of the turbines 62 and 72. The discharge valve 9 then returns to regulating the pressure P2 for speeds faster than Nt.

Given that all of these operations need to take place in a few tenths of a second, managing the actuators and controlling the actuators that generate the chronology of the operations are actions that are very complex.

The purpose of the acceleration device of the invention is to simplify the process of setting the compressor 71 of the second turbocharger 70 into action and to cause it to contribute to the air delivered to the engine starting from a speed Nt that is lower than the speed Nt of the prior art engine as described above with reference to FIG. 3.

The engine 1 fitted with the device of the invention for accelerating a turbocharger unit is shown in FIG. 4.

The configuration of this engine is identical to the configuration of the engine shown in FIG. 3 with the exception of the circuit feeding the turbine 72 of the second turbocharger 70, and the circuit delivering from the compressor 71 of said turbocharger up to the check valve 110.

This turbine 72 is fed by an aerodynamic ejector 20 whose driving flow is taken from the exhaust gas coming from the exhaust manifold 5 and whose driven flow is taken from the delivery from the compressor 71, passing via the duct 31.

This aerodynamic ejector 20 is identical to that described for the first embodiment shown in FIG. 1, with the exception that the variable nozzle 30 can close completely in leaktight manner, and the pressure that acts on the piston 35 controlling the nozzle 30 is not the pressure P21 delivered by the compressor 71, but the pressure P2 delivered by the compressor 61.

In the embodiment shown in FIG. 4, the cylinder 36 defined on one side of the piston 35 a first chamber 38 that is subjected to the reference pressure Pr, and on the other side of the piston 35, a second chamber 381 that is subjected to the pressure P2, the chamber 37 remaining subjected to the pressure P21.

In order to avoid the discharge valve 9 opening before the nozzle 30 is fully open, the feed duct 913 of the chamber 910 includes a shutter valve 914 that opens only once the nozzle 30 is against its open abutment.

In this embodiment, the feed valve 8 of the turbine 72, and the anti-pumping valve 100 of the compressor 71 of FIG. 3 are replaced by the aerodynamic ejector 20 and its check valve 32.

An example of the regulation device is shown in FIG. 4. A reference pressure Pr is established in an enclosure 12 fed by the admission manifold 3 containing the admission pressure P2, via a pressure-reducing valve 121 controlled by a control computer of the engine.

The enclosure 12 communicates with the chambers 38 and 91 of the actuators controlling the nozzle 30 and the discharge valve 9, so as to add a variable rating force to the springs 39 and 912.

A mode of operation of the installation shown in FIG. 4 is described below as occurs during acceleration of the engine.

Between idling and a speed N1, the discharge valve 9, the valve 110, and the nozzle 30 are closed, and all of the exhaust flow feeds the turbine 62, which accelerates the compressor 61 of the turbocharger 60 until the desired admission pressure P2 is reached.

Between the speed N1 and a speed Nt, the air flow rate increases at constant admission pressure P2 by progressively opening the nozzle 30 that feeds the turbine 72. The turbocharger 70 accelerates progressively and the compressor 71 of the turbocharger 70 delivers without pumping into the turbine 72 via the check valve 32 and the aerodynamic ejector 20. Downstream from the check valve 110, the pressure in the admission manifold 3 is equal to the desired admission pressure P2, and upstream from the check valve 110, it is equal to a pressure P21 that is less than said admission pressure P2. Between idling and the speed Nt, the compressor 61 alone serves to feed air to the engine.

When the speed reaches Nt, the pressure P21 reaches the admission pressure P2, and the check valve 110 opens. The compressor 71 begins to contribute to feeding air to the engine.

Above the speed Nt, the nozzle 30 continues to open to regulate the admission pressure P2, until it becomes fully open. The contribution of the compressor 71 to feeding the engine increases.

Once the nozzle 30 is open, the static pressure at its outlet matches the admission pressure P2, and the check valve 32 closes. The compressor 71 then ceases to deliver into the ejector 20.

Once the transition has been achieved, the compressors 61 and 71 share the air flow, and the admission pressure P2 is regulated by the discharge valve 9.

An advantage of the invention lies in the way in which the turbocharger 70 is brought into action progressively.

Another advantage is the lowering of the transition speed Nt. No fluid under pressure is discharged to the atmosphere, as occurs in the state of the art as shown in FIG. 3, where the discharge valve 9 and the check valve 110 co-operate to avoid pumping by the compressor 71 of the turbocharger 70. The flow of enthalpy sufficient for driving both compressors 61 and 71 at their pumping flow rate is thus reached at a lower speed.

Furthermore, each level of torque demanded of the engine corresponds to a quantity of fuel and a quantity of air that are proportional to the admission pressure P2 desired for combustion with determined richness, and determined by the map stored in the memory of a computer controlling the engine.

The position of the accelerator pedal demanding engine torque orders an admission pressure P2 from the computer, regardless of the engine speed.

In a simple embodiment of the invention, the computer acts only on the pressure-reducing valve 121 fed with the admission pressure P2 so as to establish a reference pressure Pr in the enclosure 12, which reference pressure varies with the position of said accelerator pedal. The spring 39 of the actuator for the nozzle 30 and the spring 912 of the actuator for the discharge valve 9 are rated so that when this reference pressure Pr is equal to atmospheric pressure, said nozzle 30 and the discharge valve 9 open for the desired minimum admission pressure P2.

In order to avoid the discharge valve 9 opening before the nozzle 30 is fully open, the feed duct 913 of the chamber 910 includes the shutter valve 914 that opens only if the nozzle 30 is against its open abutment.

Since the enclosure 12 is in communication with the chambers 38 and 91 of the respective actuators for the nozzle 30 and for the discharge valve 9, the enclosure 12 serves to add a variable rating force to the springs 39 and 912, thereby modifying the regulation threshold for the pressure P2. Under such conditions, the actuators of the nozzle 30 and of the discharge valve 9 regulate the admission pressure P2 to the level that is programmed in the computer controlling the engine, regardless of the speed of the engine.

In the presence of exhaust gas recycling, the parameter corresponding to the admission pressure P2 is replaced by the fresh air flow rate as measured by a flow meter situated at the inlet of the engine upstream from the recycled gas inlet.

During stages of slowing down, the various sequences take place in the opposite order.

1. A device for accelerating a turbocharger unit at low speeds of a reciprocating engine operating with a four-stroke cycle and including at least one cylinder provided with at least one admission valve connected to an admission manifold and at least one exhaust valve connected to an exhaust manifold, said turbocharger unit comprising at least one turbocharger comprising an air compressor feeding the admission manifold and a radial-flow turbine fed by the exhaust manifold and driving the compressor, the device being characterized in that it includes an aerodynamic ejector taking a driving flow from the exhaust gas of the engine and a driven flow delivered by the compressor and forming a mixed flow that feeds the turbine of the turbocharger unit.

2. A device according to claim 1, characterized in that the ejector includes a mixer that is formed by the feed volute of the turbine being extended upstream, relative to the flow direction of the mixed flow, by a substantially rectilinear portion of length that is sufficient to ensure uniform mixing between the driving flow and the driven flow.

3. A device according to claim 2, characterized in that the substantially rectilinear portion of the mixer is extended upstream by a substantially conical portion on the same axis and having an angle at the apex lying, for example, in the range 20° to 40°, and in communication with the exhaust manifold.

4. A device according to claim 1, characterized in that the ejector includes a cylindrical tube having an outside wall that is provided at one of its ends with a conical portion for co-operating with the conical portion of the mixer, said tube being movable along the axis of said mixer so that the two conical portions form an annular converging nozzle of variable section for accelerating the driving flow.

5. A device according to claim 4, characterized in that the cylindrical tube is mounted to slide in leaktight manner in a guide provided in the wall of the exhaust manifold and communicates with the outlet from the compressor via a check valve that prevents exhaust gas flowing from the exhaust manifold towards the compressor.

6. A device according to claim 4, characterized in that the section of the nozzle varies between the inlet section of the volute of the turbine and one-third of said inlet section.

7. A device according to claim 4, characterized in that the cylindrical tube is secured at its end opposite from its end provided with the conical portion, to a control piston mounted to slide in a cylinder that defines on one side of the piston a first chamber that is subjected to the pressure of the air delivered by the compressor, and on the other side of the control piston, a second chamber containing a spring acting on the piston, said pressure of the air delivered by the compressor tending to open the nozzle of the ejector, and the force of the spring tending to close the nozzle.

8. A device according to claim 7, characterized in that the second chamber communicates with a vacuum pump in order to modify or neutralize the force of the spring.

9. A device according to claim 1, in which said engine is provided with a duct for recycling exhaust gas, the device being characterized in that an air/gas heat exchanger is disposed at an intersection between the duct and a bypass duct communicating with the outlet from the compressor.

10. A device according to claim 9, characterized in that it includes a gas/water cooler situated downstream from the air/gas heat exchanger.

11. A device according to claim 4, characterized in that the cylindrical tube can be moved to a position in which the nozzle is fully closed in leaktight manner.

12. A device according to claim 1, characterized in that the turbocharger unit includes a second turbocharger comprising a turbine in permanent communication with the exhaust manifold and a compressor in permanent communication with the admission manifold, and in that the compressor communicates with the admission manifold via a check valve.

13. A device according to claim 1, characterized in that it includes means for creating a variable reference gas pressure Pr lower than a desired admission pressure P2 and that is a function of the mass of fuel injected on each cycle of the engine and possibly of other operating parameters of the engine.

14. A device according to claim 13, characterized in that said means are constituted by an enclosure connected to the admission manifold in which the desired admission pressure P2 exists, via a exhaust-reducing valve controlled by the computer controlling the engine.

15. A device according to claim 7, characterized in that the second chamber of the actuator of the nozzle is fed by the reference pressure Pr which adds to the force from the spring to close said nozzle, the force from the spring being just sufficient to keep said nozzle closed at said minimum desired admission pressure P2.

16. A device according to claim 10, characterized in that the exhaust manifold includes an atmospheric discharge valve actuated, when the nozzle is in the fully open position, by the admission pressure P2 in a first chamber so as to maintain the pressure in said chamber at a setpoint value set by a spring and the reference pressure Pr in a second chamber.

17. A reciprocating engine operating with a four-stroke cycle and including a turbocharger unit, the engine being characterized in that it includes a device according to claim 1 for accelerating the turbocharger unit at low engine speed.

18. A method of accelerating a turbocharger unit at low speeds of a reciprocating engine operating with a four-stroke cycle and including a device according to claim 1 for accelerating said turbocharger unit, the method being characterized in that it consists in closing the nozzle of the aerodynamic ejector.

19. A method of accelerating a turbocharger unit at low speeds of a reciprocating engine operating with a four-stroke cycle and including a device according to claim 1 for accelerating the turbocharger unit, together with a duct for recycling exhaust gas, the method being characterized in that it consists in obstructing said recycling duct, the section of the nozzle of the ejector being constant.

20. A method of accelerating a turbocharger unit of a reciprocating engine operating with a four-stroke cycle and including an accelerator device according to claim 1, the method being characterized in that it comprises:
between idling speed and a speed N1 where the admission pressure P2 reaches the value desired as a function of the burnt fuel flow rate, maintaining the discharge valve, the check valve, and the nozzle closed so that the engine is fed with air solely by the compressor of the turbocharger driven by the turbine of said turbocharger that receives all of the exhaust gas from the engine; and
between said speed N1 and a speed Nt at which the exhaust delivered by the compressor of the turbocharger reaches the admission exhaust P2, maintaining said admission pressure P2 at its setpoint value by progressively opening the nozzle, the discharge valve and the check valve remaining closed so that the engine is fed with air solely by the compressor of the turbocharger driven by the turbine that receives only a fraction of the exhaust gas from the engine, with the remainder feeding the turbine via the aerodynamic ejector, thereby driving the compressor that delivers solely into the turbine via said aerodynamic ejector.

21. A method according to claim 20, characterized in that, on the speed passing through the speed value Nt, the check valve opens and the compressor of the turbocharger begins to contribute to feeding the engine.

22. A method according to claim 20, characterized in that above the speed Nt, the nozzle continues to open to maintain the admission pressure P2 at its setpoint value, with the air feed to the engine by the compressor increasing.

23. A method according to claim 20, characterized in that before the nozzle becomes fully open, the static pressure at the outlet from said nozzle matches the admission pressure P2 and the check valve closes, so that all the flow rate from the compressor is then directed to the admission manifold of the engine.

24. A method according to claim 20, characterized in that, when the nozzle is fully open, the discharge valve takes over to maintain the admission pressure P2 at a setpoint value.
